(19) United States
(12) Patent Application Publication
(10) Pub. No.: US 2018/0022400 A1
(43) Pub. Date: Jan. 25, 2018

(54) GOODS MOVEMENT APPARATUS

(71) Applicant: William Mark Adams, Retford (GB)

(72) Inventor: William Mark Adams, Retford (GB)

(21) Appl. No.: 15/657,562

(22) Filed: Jul. 24, 2017

(30) Foreign Application Priority Data
Jul. 22, 2016 (GB) 1612723.5

(51) Int. Cl. B62D 33/04; E04H 5/02; E04B 1/343; B65G 69/28

(52) U.S. Cl. CPC B62D 33/042; B65G 69/2805; B65G 69/287; E04H 5/02; E04B 1/343

(57) ABSTRACT

The invention relates to a goods storage trailer including connection means to allow the trailer to be connected to a tractor unit and a plurality of wheels which allow the trailer to be moved along a surface. The trailer is formed by a base, opposing sidewalls, opposing end walls, a roof and a deck located intermediate the roof and base so as to define two storage areas within the cavity of the trailer. At one of the ends, there is provided a door assembly which is movable between open and closed positions to allow access to the cavity and the base is formed by a plurality of portions at different heights with respect to said support surface and the floor of the base and the upper deck are used to locate goods thereon.

The invention to which this application relates is to improvements to goods movement apparatus and in particular, to a trailer which is provided to be connected to a powered vehicle such as a tractor unit and so form an articulated goods vehicle.

The provision of trailers in which relatively large quantities of goods can be held in a cavity therein for transportation between first and second locations, is well known. The trailers are typically moved many miles, along the road network so as to allow, for example, goods which have arrived in the country, to be moved to location for purchase or goods to be moved from distribution hubs, to retail outlets, and the like. The goods can be individually located within the cavity of the trailer or, more typically, are provided in cages or boxes and then the cages or boxes are located in the cavity in the trailer in a more organised manner so as to maximise the usage of the available space within the cavity.

It is known to subdivide the cavity into two storage areas, and the subdivision can, in one embodiment, be achieved by the provision of a floor or deck, which is spaced from the base of the trailer cavity, so as to define a storage space between the base and the deck, and the second storage space between the deck and the roof of the trailer.

In addition to this, it is obviously desired to make the floor, space, roof, sidewalls and end walls of a form which meets the relevant legal requirements as to the allowable sin of the trailer and hence articulated vehicle for use in a geographical area, whilst also maximising the available storage space.

A further problem is caused by the loading restrictions which the trailers are required to be operated in accordance with. These restrictions can vary from country to country and in the US can vary from state to state. This can means that while the trailer may have a the capacity to handle a significantly greater number and/or weight of goods the same are operated at a reduced capacity due to loading restrictions which causes an increase in required journeys or trips than would actually be required if the load restrictions were not in place. This and other problems can also cause delays to occur in warehouse facility which receive and provide goods from and to the trailers. For example, a warehouse may receive the goods in a form in which the same are provided on pallets but, in order to then allow the goods to be transported from the warehouse via another trailer, the pallets will typically have to be opened up and the goods separated and then reformed, or the goods handled separately as they are placed into the next trailer for transport. This process, can take many hours if not days at the warehouse facility and require a significant workforce and expense to be deployed.

The aim of the present invention is to provide a trailer of a form which allows legislation to be met whilst at the same time, maximising the available storage space for goods within the trailer.

In the first aspect of the invention there is provided a goods storage trailer, said trailer including connection means to allow the trailer to be connected to a tractor unit and a plurality of wheels which allow the trailer to be moved along a surface, said trailer formed by a base, opposing sidewalls, opposing end walls, a roof and a deck located intermediate the roof and base so as to define two storage areas within the cavity of the trailer wherein, at one of the ends, there is provided a door assembly which is movable between open and closed positions to allow access to the cavity and wherein, the base is formed by a plurality of portions at different heights with respect to said support surface.

In one embodiment, the said portions of the base comprise a first set of portions which are located at a lower height with respect to the support surface and a second set of portions which are provided at a higher height with respect to the support surface. In one embodiment, the second set of portions of the base, are located above the wheels of the trailer and the axles on which the wheels are located and the said portions extend inwardly from the opposing sidewalls.

Typically the axles for the wheels are stub axles in that they do not extend from one side of the trailer to the other.

Typically the first set of portions of the base define a continuous floor level which extends at least along the majority of the length of the trailer from the rear opening towards the front end of the trailer.

In one embodiment, the provision of the first and second sets of portions, form a base along the length of the trailer between the opposing ends.

Typically, goods can be provided on both sets of portions of the base and therefore goods are provided and stored along the length of the said base.

In one embodiment, the goods are located in storage boxes or cages with wheels, so as to allow the same to be selectively positioned along the base and thereby maximise the use of the available storage space between the base and the deck.

In one embodiment, the goods located in the storage space between the deck and the roof, are provided in boxes or cages or may be independently positioned. Typically the surface on which the goods are located on the deck, is provided as a uniform surface at the same height from the support surface along the length thereof.

Typically, the deck is provided at a fixed location with respect to the remainder of the trailer. However, alternatively, the deck may be provided to be selectively moveable to different heights.

In one embodiment, the door assembly comprises first and second moveable portions, said moveable portions moveable between a first, closed position so as to fully enclose the opening into the storage space between the deck and roof and the storage space between the base and deck, and a first open position in which the upper portion is moved downwardly to overlie the lower portion and hence allow access to the opening into the storage space between the deck and the roof, and a second open position in which the lower portion is moved to overlie the higher portion of the door assembly and thereby allow access to the opening into the storage space between the base and the deck.

Typically, the higher and lower portions of the door assembly, are offset along the length access of the trailer.

In one embodiment, each of the portions is mounted on respective guide means which allow the sliding movement of the same and the portions are moveable independently between the respective positions.

Typically, the connection made between the trailer and tractor unit, are of a conventional form but at least part of the trailer connections means assembly, is located within the base of the trailer rather than protruding below the same.

In one embodiment there is provided a goods handling system incorporating a trailer as herein defined.

In one embodiment the goods handling system includes a warehouse with an opening to allow the movement of goods therethrough and a platform which is vertically movable to the heights of the base and the deck of the trailer and the platform bridges a gap between the end of the deck or base of the trailer and the opening of the warehouse to allow the goods to be moved directly between the trailer and the warehouse.

In one embodiment the goods are retained in a container such as a box or cage when in the trailer and remain in the same as they are moved from the trailer to the warehouse.

In one embodiment the goods in the container may be repositioned at the warehouse prior to being placed into position for further transport or, alternatively, are retained in the same container and placed onto a trailer for further transport from the warehouse.

Specific embodiments of the invention now describe with reference to the accompanying drawings; wherein

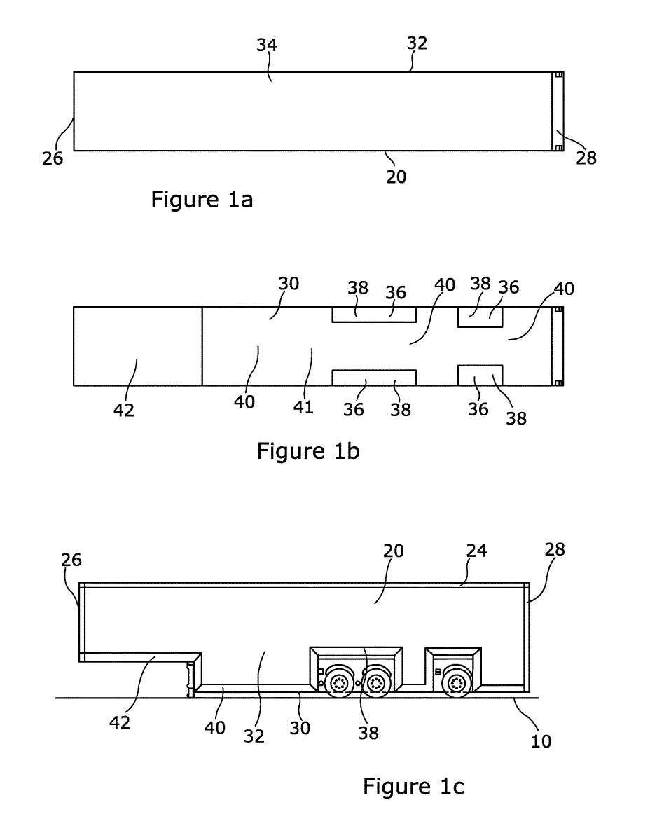

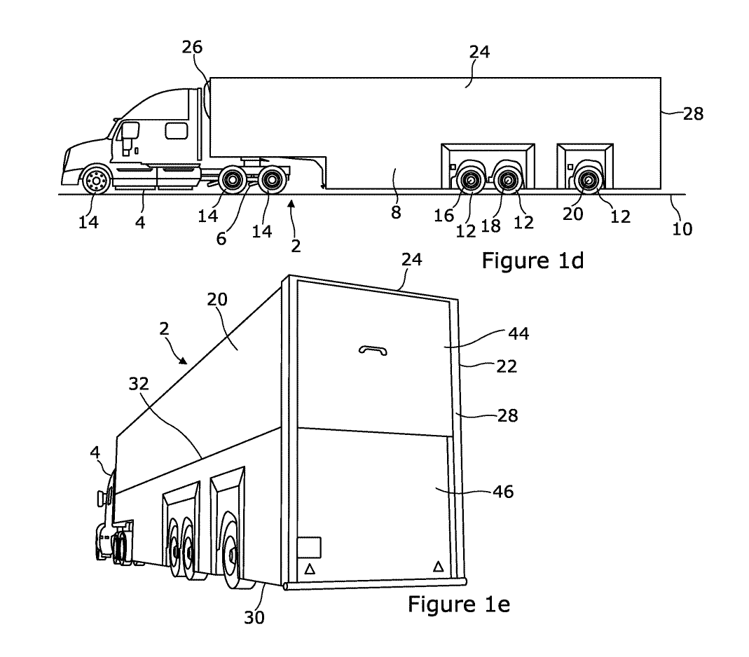

FIGS. 1a to e illustrate a trailer and articulated vehicle in accordance with one embodiment of the invention.

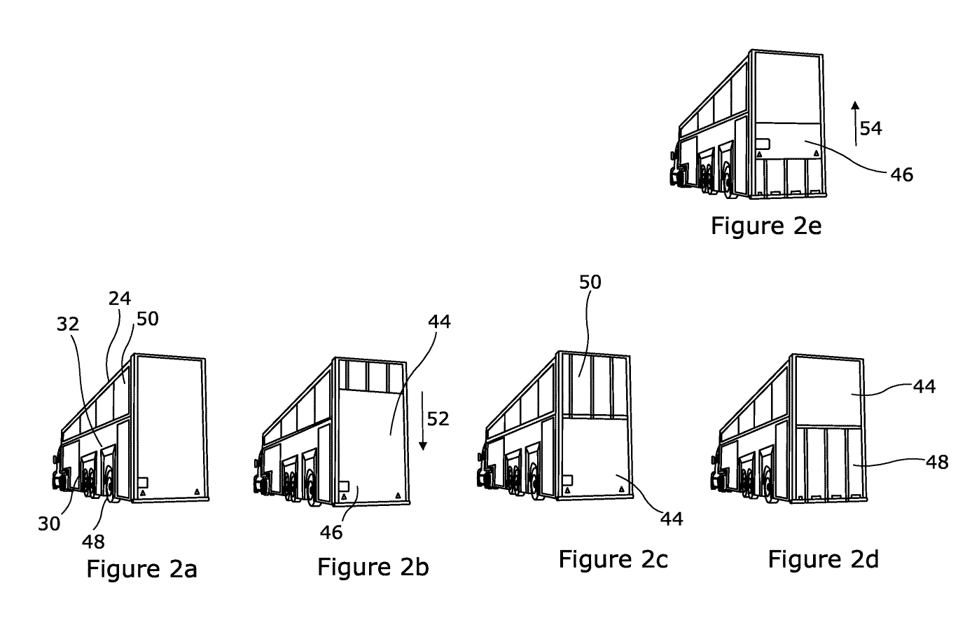

FIGS. 2a to e illustrate a door assembly of the trailer in accordance with one embodiment of the invention.

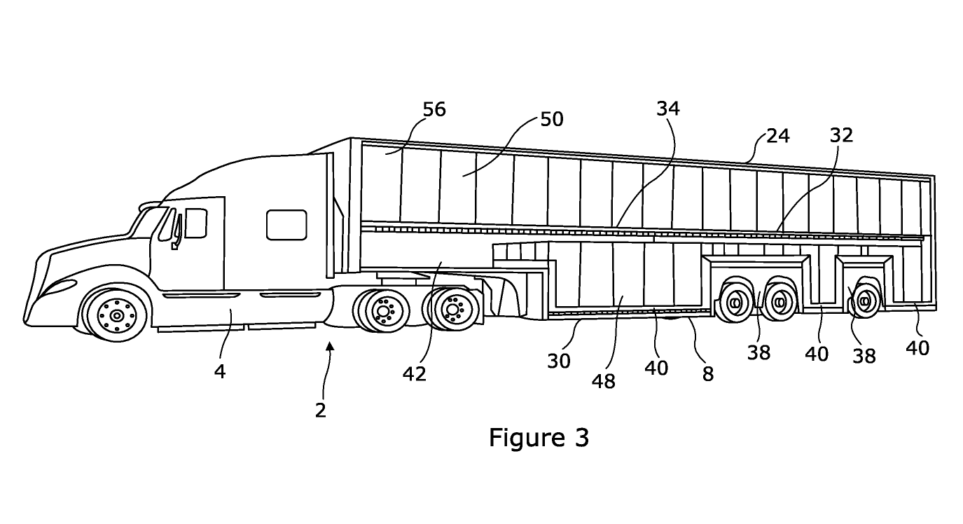

FIG. 3 illustrates the articulated vehicle with one of the sidewalls removed for ease of illustration; and

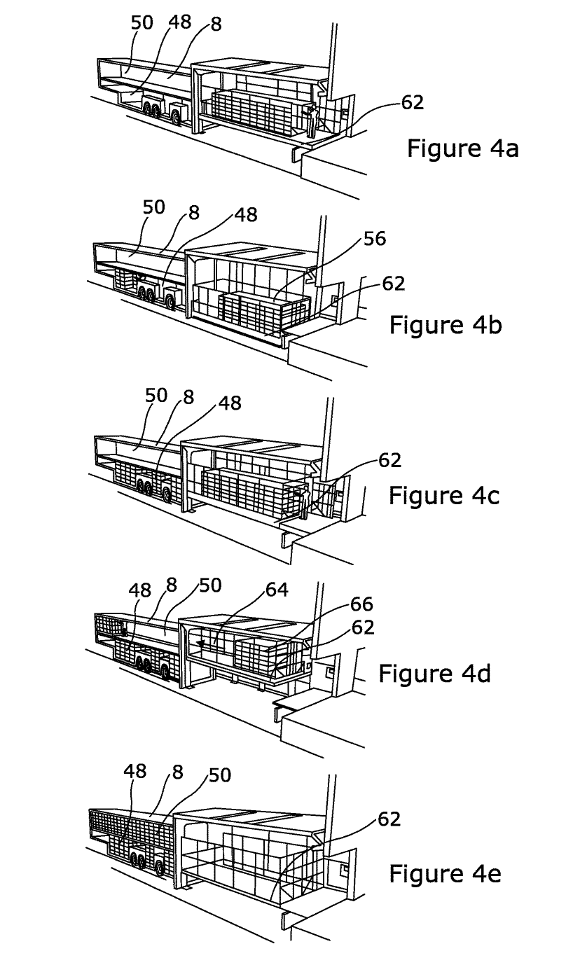

FIGS. 4a to e illustrate a goods handling system in accordance with one embodiment of the invention.

Referring firstly to FIGS. 1a to e, there is illustrated a trailer forming part of an articulated vehicle 2 which is formed by a tractor unit 4 to which is connected via connection means 6, the trailer 8. The vehicle is provided to be moved across a support surface such as a road 10 with which the wheels 14 of the tractor unit and wheels 12 of the trailer contact. In the embodiment shown, the trailer includes three sets of wheels mounted in respect of stub axles 16, 18 and 20.

The trailer is formed of opposing sidewalls 20 and 22, a roof 24, opposing end walls 26 and 28, a base 30 and deck 32 located intermediate the base 30 and roof 24. FIGS. 1a and b illustrate plan views of the deck 32 and base 30 respectively and it will be seen that the deck 32 has a top surface 34 which is substantially uniform in its height with respect to the support surface 10.

In contrast, the base 30 has a plurality of box portions 36 to accommodate the location of the wheels 12 and stub axles of the trailer. The height of this upper set of portions 38 are provided at a greater distance from the support surface 10 than are the lower set of portions 40 which form the lowest portions of the base. There is also provided a further portion 42 which can be at the same height as the portions 38 or may be at a height intermediate the portions 38 and the portions 40 of the base and this portion 42 is provided to provide sufficient space underneath for the connecting means with the tractor unit 4.

The lower set of portions 40 form a path 41 which is of the same height and extends from the rear opening end 28 to the front end 26. This allows ease of movement for operatives loading or unloading the trailer and/or for the rolling of cages along the same and in which cages the goods are held.

Shown in FIG. 1e, is the rear end 28 of the trailer and which includes a door assembly formed of a higher portion 44 and a lower portion 46 which are independently moveable so as to allow the door assembly to be moved between a closed position shown in FIG. 1e and FIG. 2a and two open positions as now explained with regard to FIGS. 2a to 2e.

In FIG. 2a, the door assembly is shown in a closed position so that no access is possible to either of the storage areas 48 formed between the underside of the deck 32 and the portions 38, 40 and 42 of the base 30 or the storage area 50 defined between the deck 32 and the roof 24. The trailer will normally be transported with the door assembly in this position.

In order to move the door assembly to a first open position, then the portion 44 of the door assembly is moved to overlie the portion 46 of the door assembly with movement performed as indicated by arrow 52 in FIG. 2b, to bring the portion 44 to overlie the portion 46 as shown in FIG. 2c and hence allow access to the storage area 50.

The second open position shown in FIG. 2d, is achieved by moving the lower portion 46 from the closed position shown in FIG. 2a as indicated by arrow 54 in FIG. 2e, so that the lower portion is located behind the higher portion 44 as indicated in FIG. 2d and thereby allow access to the goods storage area 48.

FIG. 3 illustrates the trailer 8 with the sidewall 22 removed and shows a fully laden trailer in accordance with the invention in which the surface 34 receives thereon a plurality of stacked tote boxes 56 and the tote boxes contain therein, the goods which are to be transported. In the goods storage area 48, it is shown that the portion 42 of the deck is empty but the tote boxes are located on the portions 40 of the deck 30 and these portions extend between the sections 38 and thereby maximise the use of the deck 30 and hence the goods storage area 48.

FIGS. 4a to e illustrate the use of a goods handling system in accordance with the invention and illustrate the manner which the trailer 8 in accordance with the invention can be loaded sequentially by movement of the door assembly to allow access to the respective goods storage areas 48 and 50 and also the movement of the platform 62 on which the goods are located as they are moved between the trailer and the warehouse.

In FIG. 4b, the platform 62 is at a lowered height and the door assembly is in a position as shown in FIG. 2d so as to allow the container such as boxes or rollable cages 56 in which the goods are located to be moved from the platform 62 and into the goods storage area 48. Once this is loaded then the platform 62 is moved to a higher position shown in FIG. 4d and the door assembly is moved to the open position as shown in FIG. 2c so as to allow the boxes or cages 56 on the platform to be moved as indicated by arrow 64 to load the storage area 50 of the trailer so that, as illustrated in FIG. 4e, the trailer can then be fully laden quickly and efficiently.

1. A goods storage trailer, said trailer including connection means to allow the trailer to be connected to a tractor unit and a plurality of wheels which allow the trailer to be moved along a surface, said trailer formed by a base, opposing sidewalls, opposing end walls, a roof and a deck located intermediate the roof and base so as to define two storage areas within the cavity of the trailer wherein, at one of the ends, there is provided a door assembly which is movable between open and closed positions to allow access to the cavity and wherein, the base is formed by a plurality of portions at different heights with respect to said support surface.

2. A trailer according to claim 1 wherein the said portions of the base comprise a first set of portions which are located at a lower height with respect to the support surface and a second set of portions which are provided at a higher height with respect to the support surface.

3. A trailer according to claim 2 wherein the second set of portions of the base arc located above the wheels of the trailer and the axles on which the wheels are located and the said portions extend inwardly from the opposing sidewalls.

4. A trailer according to claim 3 wherein the axles for the wheels are stub axles.

5. A trailer according to claim 1 wherein the first set of portions of the base define a substantially continuous floor level which extends at least along the majority of the length of the trailer from an opening at the rear end wall towards the front end wall of the trailer.

6. A trailer according to claim 1 wherein the provision of the first and second sets of portions form a base along the length of the trailer between the opposing ends.

7. A trailer according to claim 1 wherein goods can be provided on both sets of portions of the base and therefore goods are provided and stored along the length of the said base.

8. A trailer according to claim 1 wherein the goods are located in storage boxes or cages with wheels.

9. A trailer according to claim 1 wherein the surface on which the goods are located on the deck, is provided as a uniform surface at substantially the same height from the support surface along the length thereof.

10. A trailer according to claim 1 wherein the deck is provided at a fixed location with respect to the remainder of the trailer.

11. A trailer according to claim 1 wherein the deck is provided to be selectively moveable to different heights.

12. A trailer according to claim 1 wherein the door assembly comprises first and second moveable portions, said moveable portions moveable between a first, closed position so as to fully enclose the opening in the rear wall into the storage space between the deck and roof and the storage space between the base and deck, and a first open position in which the upper portion is moved downwardly to overlie the lower portion and hence allow access to the opening into the storage space between the deck and the roof, and a second open position in which the lower portion is moved to overlie the higher portion of the door assembly and thereby allow access to the opening into the storage space between the base and the deck.

13. A trailer according to claim 12 wherein the higher and lower portions of the door assembly, are offset along the length axis of the trailer.

14. A trailer according to claim 12 wherein each of the portions is mounted on respective guide means which allow the sliding movement of the same and the portions are moveable independently between the respective positions.

15. A goods handling system incorporating a trailer as defined in claim 1.

16. A system according to claim 15 wherein the goods handling system includes a warehouse with an opening to allow the movement of goods therethrough and a platform which is vertically movable to the heights of the base and the deck of the trailer and the platform bridges a gap between the rear end of the trailer and an opening into a warehouse to allow the goods to be moved directly between the trailer and the warehouse.

17. A system according to claim 16 wherein the goods are retained in a container when in the trailer and remain in the same as they are moved between the trailer and the warehouse.

18. A system according to claim 17 wherein the goods in the container are repositioned at the warehouse prior to being placed into position for further transport.

19. A system according to claim 17 wherein the goods are retained in the same container and placed onto a trailer for further transport from the warehouse.
